(19) United States
(12) Patent Application Publication
(10) Pub. No.: US 2013/0263673 A1
(43) Pub. Date: Oct. 10, 2013

(54) METHOD OF QUALITY CONTROL FOR DETERMINING THE COMPRESSIVE STRENGTHS OF GROUT IN MULTIPLE MOLDS

(71) Applicant: HEINTZMANN CORPORATION, Cedar Bluff, VA (US)

(72) Inventors: Joseph P. Bower, Morgantown, WV (US); John Kenneth Vallens, Ladera Ranch, CA (US)

(73) Assignee: Heintzmann Corporation, Cedar Bluff, VA (US)

(21) Appl. No.: 13/710,594

(22) Filed: Dec. 11, 2012

Related U.S. Application Data
(60) Provisional application No. 61/686,287, filed on Apr. 4, 2012.

(51) Int. Cl. G01N 3/08

(52) U.S. Cl. CPC G01N 3/08
USPC 73/821

(57) ABSTRACT

A method for testing compressive strength of multiple molds filled with a liquid settable grout wherein samples of the liquid settable grout are taken at selected filling intervals and poured into a container, and the container is sealed and the time, date and location information regarding the mold then being filled is recorded on the container. The sample container is then left in the same environment as the mold being sampled. A curve is generated which projects a final compressive strength based on compressive strengths at various cure times. The sample is removed from its container after a selected cure time and subjected to a series of Schmidt hammer tests, and these compressive strength readings are used to determine the projected final compressive strengths of the sample based on the cure time from the established curve.

### CROSS REFERENCE

This application claims the benefit of U.S. Provisional Patent Application No. 61/686,287, filed Apr. 4, 2012, and entitled METHOD OF QUALITY CONTROL FOR DETERMINING THE COMPRESSIVE STRENGTHS OF GROUT IN PUMPABLE MINE CRIBS, the contents of which are incorporated herein in their entirety.

### BACKGROUND OF THE INVENTION

The method of the present invention pertains to the testing of compressive strength of multiple molds filled with a liquid settable grout. The method of the present invention is particularly applicable for quality control for determining the compressive strength of support columns formed by pumpable grout bags in mining operations in order to support the roof or hanging wall.

Conventional grout bags or pumpable cribbing bags are essentially closed geotextile containers which typically have some means of suspending them on support structures. The bags are inflated by pumping a liquid settable grout into the bags, wherein the grout is permitted to cure or set to develop sufficient strength to carry load. This invention pertains to a new process for testing compressive strength of such pumpable cribs or other molds.

Because of preparation and handling, it is not feasible to make traditional three by six inch compressive strength cylinders for crush tests underground in a coal mine when installing pumpable cribs.

### SUMMARY OF THE INVENTION

The present invention provides a method for testing compressive strength of multiple molds, such as pumpable cribbing bags for mines, filled with a liquid settable grout. First a series of molds, such as pumpable cribs, are filled with liquid settable grout. At selected mold filling intervals, samples of the liquid settable grout are poured into a container and the container is sealed and the time, date and location information regarding the mold then being filled is recorded on the container. The sample container is subjected to the same environment as the mold being sampled is subjected to.

A curve is generated or established which projects a final compressive strength based on compressive strengths at various cure times. The sample is removed from its container after a selected cure time and the sample is subjected to a series of Schmidt rebound hammer tests, thereby obtaining a series of compressive strength readings. The projected final compressive strength of the samples is then determined based on the cure time of the sample from the established curve.

If desired, a core sample from the cured grout sample may be taken and subjected to a crush test to thereby confirm the projected compressive strength results. It is also preferable that the container be selected to provide a flat smooth surface on the cured sample for conducting the Schmidt hammer test.

The method is repeated over and over again on multiple grout samples taken at different selected intervals from different molds or pumpable cribs.

### BRIEF DESCRIPTION OF THE DRAWING

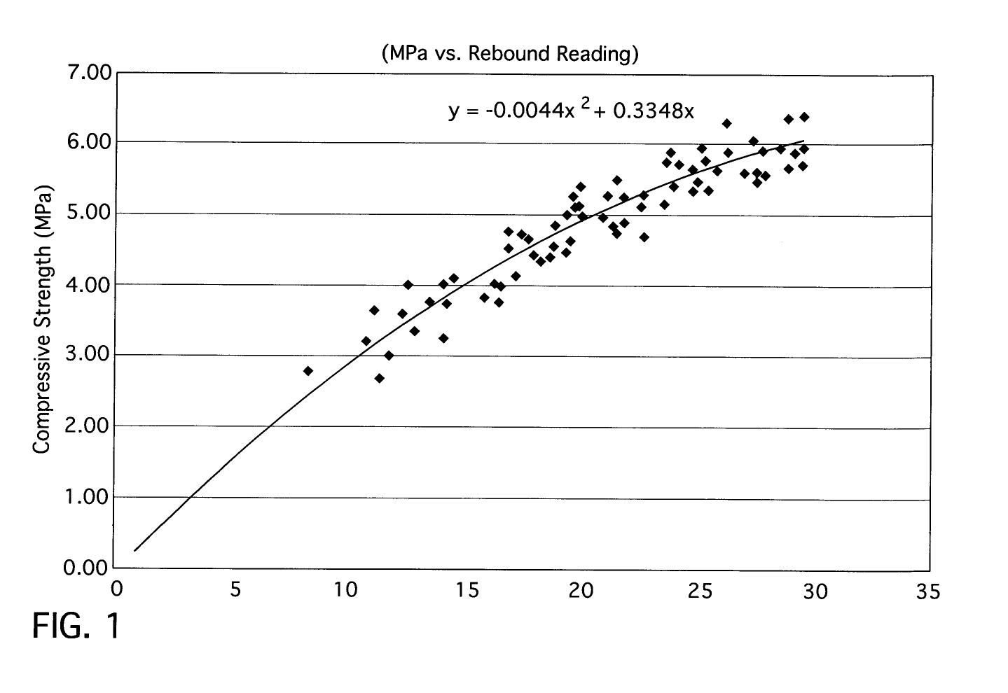

Other objects and advantages appear hereinafter in the following description and claims. The accompanying drawing shows, for the purpose of exemplification, without limiting the scope of the invention or the accompanying claims, certain practical embodiments of the present invention wherein FIG. 1 is a curve generated to project a final compressive strength of the liquid settable grout based on compressive strengths determined at various cure times.

### DETAILED DESCRIPTION OF A PREFERRED EMBODIMENT

The method of the present invention for providing quality control to determine the compressive strengths of liquid settable grout being used to fill molds will be discussed in regard to pumpable cribs for providing roof support in underground mines.

First, a series of pumpable mine crib bags which are supported in place in the mine are filled with liquid settable grout. At selected crib bag filling intervals, samples of the liquid settable grout are poured into a container and the container is sealed and the time, date and location information regarding the particular crib bag is then recorded on the container. The sample container may for example consist of a five gallon plastic bucket, and the selected interval for testing or sampling may for example be selected as every tenth crib bag. Pouring of the sample is accomplished by taking the injection nozzle for pumping the pumpable grout into the crib bags off the inlet port of the crib bag and the disconnected nozzle is used to fill the test or sample container.

After the lid has been placed on the bucket and the time, date and location of the crib bag being filled is recorded on the bucket or bucket lid, the bucket is then left in the same area as the pumpable crib bag being pumped or filled so that the crib bag and the sample will both be subject to the same environment. The time from when the sample is poured and when it is tested can vary since the inventors have established a curve projecting a final compressive strength based on compressive strengths taken at various cure times. This curve is shown in FIG. 1.

The curve of FIG. 1 was established by obtaining compressive strength values from a number of test cylinders with rebound hammer values obtained from testing nominal times on the cured material. Compressive strength values were observed from 2.7 MPa through 6.4 MPa (390 psi through 930 psi). Plotting the Rebound Values vs. Compressive Strength and getting a best-fit 2^{nd} order polynomial line results in the equation displayed on FIG. 1.

If, for example, one were to decide to test the samples after 24 hours of cure time, the bucket lid is removed and the bucket is turned upside down. The bucket walls taper inward from top to bottom and thus allow the sample to be easily removed with no damage to the sample. The bottom of the bucket is smooth and therefore provides a smooth flat surface on the sample which eliminates the need to cut and polish the sample in order to achieve a suitable surface for testing and allows accurate testing on site. A Schmidt rebound hammer, sometimes also referred to as a Swiss hammer or simply a rebound hammer, is then used to obtain a series of readings, say for example 10. The Schmidt hammer is a device commonly used to measure the elastic properties or compressive strength of concrete or rock, mainly surface hardness and penetration resistance.

The Schmidt hammer is previously programmed to convert the readings into a compressive strength of the grout.

At this stage, the inventors then go to their chart as illustrated in FIG. 1 which shows a projected final compressive strength based on what the compressive strength is at the particular cured time, for example 24 hours. The sample is then placed back into the bucket and the lid resealed. This is done for two reasons. First of all, further Schmidt hammer tests can be performed at later cure times if desired. Secondly, by using such a five gallon bucket as the mold to take the sample, the sample is large enough to take to a lab, core at a three inch by six inch cylinder and perform a conventional crush test to confirm the results of the method of the present invention.

We claim:

1. A method for testing compressive strength of multiple molds filled with a liquid settable grout, comprising:
filling a series of molds with liquid settable grout;
at selected mold filling intervals pouring a sample of the liquid settable grout into a container, sealing the container and recording the time, date and location information regarding the mold then being filled on the container;
subjecting the sample container to the environment of the mold sampled;
establishing a curve which projects a final compressive strength based on compressive strengths at various cure times;
removing the sample from its container after a selected cure time;
subjecting the sample to a series of Schmidt hammer tests and thereby obtaining a series of compressive strength readings; and
determining the projected final compressive strength of the sample based on the cure time from the established curve.

2. The method of claim 1, taking a core sample from the cured grout sample and subjecting the sample to a crush test to thereby confirm the projected compressive strength results.

3. The method of claim 1, wherein said container is selected to provide a flat smooth surface on the cured sample for conducting the Schmidt hammer tests.

4. The method of claim 1, repeating the claimed method on multiple grout samples taken at different selected intervals.

5. The method of claim 1, wherein said molds are pumpable mine cribbing bags.

6. The method of claim 5, the step of filling accomplished by pumping the liquid settable grout through a hose.
